(19) United States
(12) Patent Application Publication
(10) Pub. No.: US 2016/0345594 A1
(43) Pub. Date: Dec. 1, 2016

(54) EDIBLE PROTEIN AND CARBOHYDRATE GLASS-LIKE COMPOSITIONS

(71) Applicants: Leslie Marie Norris, San Rafael, CA (US); Megan Alexander Fisklements, Oakland, CA (US); Edward Hirschberg, South San Francisco, CA (US); Zhongli Pan, El Macero, CA (US); Tara H. McHugh, Albany, CA (US)

(72) Inventors: Leslie Marie Norris, San Rafael, CA (US); Megan Alexander Fisklements, Oakland, CA (US); Edward Hirschberg, South San Francisco, CA (US); Zhongli Pan, El Macero, CA (US); Tara H. McHugh, Albany, CA (US)

(21) Appl. No.: 14/726,256

(22) Filed: May 29, 2015

(51) Int. Cl. A21D 2/36; A21D 2/26; A21D 6/00; A21D 2/18

(52) U.S. Cl. CPC A21D 2/36; A21D 2/186; A21D 2/267; A21D 6/005

(57) ABSTRACT

A composition including a matrix of at least one of a carbohydrate ingredient and a protein ingredient including a crunch in the absence of saturated fats. A composition including a matrix of at least one of a carbohydrate ingredient and a protein ingredient and an inclusion, wherein the composition includes an amount of one or more nutrients in the composition provided by the inclusion that is greater than an amount of the one or more nutrients in the inclusion processed without a matrix. A method including forming a dough including a matrix including at least one of a carbohydrate ingredient and a protein ingredient; and energy activating the dough; and forming a composition including a crunch.

### BACKGROUND

A shift toward consumption of processed foods is contributing to a rising worldwide epidemic of obesity and related diseases. It is crucial to begin making processed foods that provide nutrition instead of empty calories. To be successful in the marketplace, such nutrient dense processed foods must appeal to consumers in terms of texture, flavor and appearance.

Traditionally, “crunchy” chips are fried or baked, both of which use and/or contain 15 percent to 40 percent oil in their composition. Snack crackers are baked and typically contain 2 percent to 25 percent oil. Dried fruits and vegetables are washed and then laid out in the sun to dry. Liquid flavors are typically made into emulsions and spray dried at 250° F. for 10 to 60 seconds creating a dry powder.

While other dehydration methods may create food with a crunchy texture, crunchiness is an inherent quality of the specific food material (i.e. sugar content) and the process by which the food material is prepared. For example, vacuum microwave is used to create “puffed” blueberries, which retain the piece identity of whole blueberries and are slightly crunchy. Freeze drying has been used for decades to dry strawberries into crunchy pieces for addition to breakfast cereal. However, the result of these processes is a finished dried product, which is light and airy, and lacking in density and not the crunch of a fried chip. That is, these other processes generally will not work on an arbitrary choice of food material or an arbitrary blend of food materials to create a dense crunchy piece or chip.

### SUMMARY

A composition including a protein- and/or carbohydrate-rich crunchy food or ingredient and a method or process of forming a crunchy food or ingredient including forming a slurry or dough including a matrix including a protein- and/or carbohydrate-rich ingredient, a matrix optionally in combination with inclusions, energy/heat activating and drying. A wide range of inclusions can be incorporated with the protein- and/or carbohydrate-rich ingredient(s), including but not limited to, gas (e.g., air), seeds, nuts, dry or fresh vegetable and fruit pieces, purees, and pomace skins In one embodiment, the composition delivers the nutrition (nutrients) and/or flavor of the starting material inclusions while creating a crunchy texture similar to a fried chip, without frying. In one embodiment, a composition is prepared without the addition of oil (e.g., without the addition of saturated fatty acids typically used with fried and baked crackers). It is possible that one or more of the described ingredients in a composition contain a small amount of natural fat (e.g., unsaturated fatty acids). Due to the described matrix and process, healthy inclusions can serve as primary ingredients for the formation of a dense crunchy piece or chip. The composition and method allow arbitrary inclusions chosen for their nutrients and flavor to serve as primary ingredients to form a crunchy piece or chip where the crunchiness would not otherwise be possible without the matrix/activation described. Incorporating flavor and or nutrients within a small crunchy “piece”, provides to create a delivery system that can be used to deliver fresh flavor and nutrition in a consumer friendly form to processed foods. In one embodiment, it is possible to deliver one to three servings of vegetables in a 30 gram serving of a composition in the form of multiple chips.

### BRIEF DESCRIPTION OF THE DRAWINGS

FIG. 1 shows a side view image of an embodiment of a finished composition including incorporation of air as an inclusion.

FIG. 2 illustrates a process flow diagram of forming a crunchy piece or chip.

FIG. 3A shows an electron micrograph of dehydrated beet pomace dried with no matrix at 80× magnification.

FIG. 3B shows an electron micrograph of dehydrated beet pomace in a matrix and dried at 80× magnification.

FIGS. 4A-4B show scanning electron micrographs illustrating the difference between a non-activated matrix (FIG. 4A) and an activated matrix (FIG. 4B) with final air-drying to form a chip. The finished chip was composed of protein and carbohydrate with a spinach inclusion.

FIG. 5 shows a graph comparing the relative retention of micronutrients/bioactives in a chip made with and without activation of the matrix with infrared radiation and a final air-drying to form a chip. The finished chip was composed of high-protein algae and carbohydrate with a spinach inclusion.

FIG. 6 shows a graph comparing the relative retention of micronutrients/bioactives in a spinach chip made with and without matrix, with infrared activation and final air-drying to form a chip. The finished chip was composed of either spinach pomace alone, or a high-protein algae matrix with spinach pomace inclusion.

FIGS. 7A-7D show four micrographs comparing no matrix versus matrix added to spinach pomace as an example pomace, with and without infrared radiation as an example activation process.

FIGS. 8A-8B show graphs comparing the organoleptic and texture meter qualities of spinach chips made with high protein matrix versus no matrix.

FIG. 9 shows micrograph of a chip made with a starch matrix, spinach pomace inclusion, infrared activation and air-drying.

FIGS. 10A-10B show organoleptic and texture meter qualities of spinach chips made with a starch matrix versus no matrix, both infrared activated and air-dried.

FIG. 11 shows organoleptic and texture meter qualities of spinach chips with several different matrices, compared to those of chips made with no matrix.

FIG. 12 shows a comparison of fracturability of a carrot chip with and without a matrix to different commercial brands of fried or baked potato chips.

### DETAILED DESCRIPTION

A composition including a matrix of carbohydrate-based ingredients and/or protein-rich ingredients is described, which when activated and finish-dried, produces a crunchy edible piece. Inclusions such as gas (e.g., air), dry or fresh fruits and vegetables in pieces, purees, or extracts thereof, seeds, nuts, other edible particulates, bioactives (vitamin D3, etc.) and liquid and dry flavors may be utilized to deliver character, flavor, nutrition, and color to the final composition (e.g., a chip/piece). In one embodiment, the composition has a glass-like structure in the sense that the composition will fracture or break apart rapidly into small pieces in response to a chewing force and not get pulpy upon chewing.

Carbohydrate-rich ingredients can be extracts or whole foods sources that contain starch/polysaccharides. Carbohydrate sources representatively include a starch such as, but not limited to, raw potato (Solanum tuberosom), tapioca/cassava/manioc (Manihot esculenta), turnips (Brassica rapa), rice, corn, or extracts thereof. Other carbohydrate sources including glycerol and other sugar alcohols; syrups such as tapioca, sorghum, rice, and cane; gums or thickeners such as gum arabic and carboxymethylcellulose; gelling agents such as glucomannan. Carbohydrate-rich ingredients include a single ingredient or carbohydrate source, or a combination of ingredients, such as two or more carbohydrate sources. In one embodiment, a carbohydrate-rich ingredient is an ingredient containing 25 percent or more of carbohydrate (CHO) on a dry weight basis.

Protein-rich ingredients include extract or whole food ingredients containing protein. An example of a whole food protein source includes algae such as green algae (heterotrophic Chlorella protothecoides, that has a protein content typically around 60-66 percent), blue green algae (Spirulina maxima, Spirulina platensis, 60-65 percent protein). Dairy sources of protein include milk (liquid 3.4 percent, powdered 36 percent), yogurt (3.4-5.7 percent, powdered 36 percent), cheese (17-42 percent; powdered 16 percent) and extracts thereof including whey protein (12-90 percent) and casein (24-70 percent). Protein-rich ingredients include a single ingredient or single protein source, or a combination of ingredients, such as two or more protein sources. In one embodiment, a protein-rich ingredient is an ingredient containing 25 percent or more protein on a dry weight basis.

The carbohydrate-rich ingredient and/or a protein-rich ingredient, in an embodiment, is formed into a matrix of a dough having a representative moisture content between 10 percent and 95 percent with the higher moisture content dough resembling a slurry. The matrix can be formed in a slurry or dough with or without one or more inclusions. The matrix is then activated with energy/heat and formed, in either order, then finish-dried. The resulting product is a crunchy edible piece or chip that can be used as a snack-type food, or can be broken into smaller pieces. The chip and/or pieces deliver nutrition, flavor and/or texture. The same ingredient can be both protein-rich and carbohydrate-rich simultaneously.

Representative inclusions include one or more of a fruit portion, a vegetable portion, a legume portion, a nut portion, a seed portion, a spice portion, and an herb portion wherein a portion represents an entire portion (e.g., a whole fruit, whole vegetable, whole nut) or a portion less than the entire portion (e.g., a piece or pieces of a whole fruit, vegetable or nut, a pomace, an extract). The inclusion may also be modified from its natural state prior to combining with the carbohydrate-rich and/or protein-rich matrix. Such modification includes but is not limited to sliced, chopped, fragmented, pureed, and pulverized. One or more auxiliary inclusions of gas (e.g., air), a flavor, a nutrient (e.g., a vitamin, mineral, nutritional supplement) and a color may also be included in a composition. In one embodiment, an amount of one or more inclusions, including auxiliary inclusions, is up to 95 percent of the composition by weight. In another embodiment, an amount of inclusions is 30 percent or more by weight, such as 30 percent to 95 percent by weight of the composition.

In one embodiment, one or more inclusions are combined with or in a matrix of a carbohydrate-rich and/or a protein-rich ingredient in an amount up to 95 percent by weight of a finished dried composition or product. In another embodiment, one or more inclusions are combined with or in a matrix of a carbohydrate-rich and/or protein-rich ingredient in an amount of 10 percent to 70 percent by weight of a finished dried composition or product. In another embodiment, the percentage is 10 percent to 50 percent by weight of the dried product and in still a further embodiment, the percentage is 10 percent to 30 percent of the dried product.

The activation to form a crunchy composition (e.g., chip) can be accomplished using a variety of energy transfer methods. In one embodiment, electromagnetic or radiative energy, such as infrared or microwave energy, can be used. A representative dwell time for activation of a matrix of a dough by infrared or microwave energy (radiation) is on the order of 60 second to 120 seconds, or more broadly, 30-300 seconds of dwell time followed by finish-drying at 120-170F. In the case of infrared radiation, a representative intensity is between 3,000-5,000 watts per square meter (W/m²), and a representative energy wavelength of activation is between 0.78-1000 micrometers, or more specifically, between 1-12 micrometers. Infrared energy activation brings the advantage of a microbiological kill step, efficient water removal, flavor generation (browning), slight to moderate cooking of inclusions, and retention of nutrients. Conductive energy transfer such as a hot water bath can alternatively be used for activation by, for example, boiling the dough for two or more minutes. Alternative processing techniques such as high-pressure processing, induction heating, or pulsed electric field energy transfer may also be used. Similarly, finished drying may be accomplished using a variety of methods, including but not limited to air, infrared radiation, conduction and convection heating. The activation and optional finished drying results in a composition having a glass-like solid state that yields a fracture force (as measured as force to break on a texture analyzer) on the order of 1.5 to 5 Newtons, similar to a potato chip made in the presence of frying oil (e.g., a fried potato chip containing 24 to 40 percent amount of oil).

A representative thickness of a dough matrix as a sheet or generally planar substrate is 0.22 millimeters (mm) to 1.4 mm. A target dough thickness varies depending on a forming method, activation method, degree of inclusion incorporation (e.g., gas incorporation).

In one embodiment, an activation such as infrared radiation of some or all of the matrix ingredients and/or inclusion ingredients substantially alters and improves the crunchy product composition, as measured by structure, texture, analytical or organoleptic properties of the finished product.

In one embodiment, the composition provides a method to deliver the nutrition of fruits, vegetables in a crunchy cost effective, consumer friendly form. In one embodiment, a serving size of the composition is on the order of 20 grams to 30 grams. In one embodiment, a serving size of the composition includes up to three servings of a vegetable or fruit portion with a serving based on determinations made by the United States Department of Agriculture and United States Department of Health and Human Services, Dietary Guidelines for Americans, 2010.

By incorporating inclusions such as plant or fruit tissue into a matrix with at least one carbohydrate ingredient and/or at least one protein ingredient, plant or fruit tissue damage can be minimized. It is believed that the generally intact or undamaged plant or fruit tissue provides a favorable crunchy texture to the final production composition. In addition, encasing one or more inclusions in an activated matrix offers protection of the inclusion(s) from oxidation, enzyme degradation and/or volatile flavor loss.

In one embodiment, wherein the matrix includes one or more protein ingredients with or without one or more carbohydrate ingredients, such ingredients create a three-dimensional structure which organoleptically forms a crunchy texture, and shelf-stable finished food piece. The protein ingredients substantially alter and improve the crunchy structure, as measured by organoleptic, texture, microscopic or analytical measurements. In one embodiment, the addition of protein ingredients modifies a glass transition of an activated matrix relative to a composition formed in a similar manner but without one or more protein ingredients.

In one embodiment, a matrix of whole food based high-protein algae (25 percent dry weight) is blended with a flavoring ingredient inclusion (74 percent dry weight). The mixture is treated with infrared radiation, poured onto a forming tray, and finish-dried via forced hot air. The resulting product is a crunchy edible sheet that can be used as a flavoring ingredient in foods, or can be crumbled into smaller pieces for use as a topping or crunchy ingredient for savory or sweet applications. In this embodiment, the high-protein algae contains of 28 percent by dry weight carbohydrates, and as such, constitutes both a protein-rich and a carbohydrate-rich ingredient.

In another embodiment, a matrix of dried Spirulina algae (protein-rich source) was blended with tapioca starch (carbohydrate-rich source) to form a dough. The dough activated with infrared radiation, then formed into a sheet and air dried to produce a finished product. The finished chip preserved chlorophyll, phycocyanin, and other micronutrients found in the Spirulina starting material.

In still another embodiment, a matrix of carbohydrate-rich starch (tapioca) and an inclusion of fruit and/or vegetable pieces, puree or pomace were mixed to form a dough. The resultant dough was IR treated, sheeted and hot air dried to produce a crunchy finished product retaining nutrition (carotenoids, vitamins, minerals) found in the vegetable pieces, puree, or pomace.

In a further embodiment, a matrix of whole food high-protein algae was blended with air and flavor inclusions. It was found that the matrix entraps the introduced flavor. Organoleptically, the flavor character and concentration are retained through activation, dehydration, and storage.

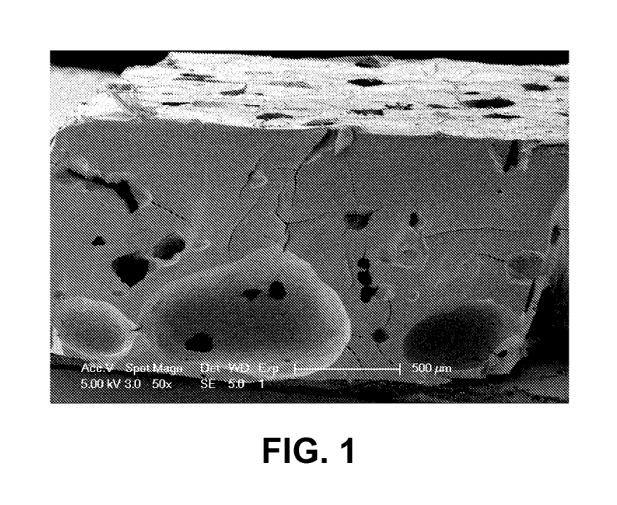

With regard to introducing and/or capturing a gas such as air into the matrix, non-exclusive examples of techniques to introduce/capture air/gas within a matrix include nitrogen gas introduction using a injection former; capture using a whisk or other mechanical beating process; or “creaming” a dough containing 25 percent to 90 percent wet vegetable matter to incorporate air bubbles, as is common in cookie dough production. It has been found that matrix is adept at air entrapment. FIG. 1 shows a side view of a finished composition including an air inclusion. FIG. 1 illustrates an otherwise dense matrix surrounding pockets or air inclusions. Once the matrix encapsulates air bubbles, even the popping of a bubble at the surface of the drying matrix does not lead to release of the bubble shape by the matrix. This is evidenced by pore-like openings on the surface of the dried matrix piece shown in FIG. 1 that have no remnant of bubble film around their edges. Furthermore, cracks emanating radially from the bubble opening indicate that the matrix was not completely dry (shrunk) when the opening was formed, yet the matrix maintained the bubble structure rather than closing in around it.

In a still further embodiment, a matrix composed of a protein-rich source of whey protein concentrate (11 percent dry weight) and a carbohydrate-rich source of tapioca starch (35 percent dry weight) is mixed with inclusions of fruit and/or vegetable pieces, puree or pomace (52 percent dry weight), seeds, nuts, and/or grains. The resultant dough of the mixture is formed, (with minimal tissue damage) energy activated, sheeted and hot air-dried producing a crunchy snack-type product retaining the flavor, and nutrition of the inclusions.

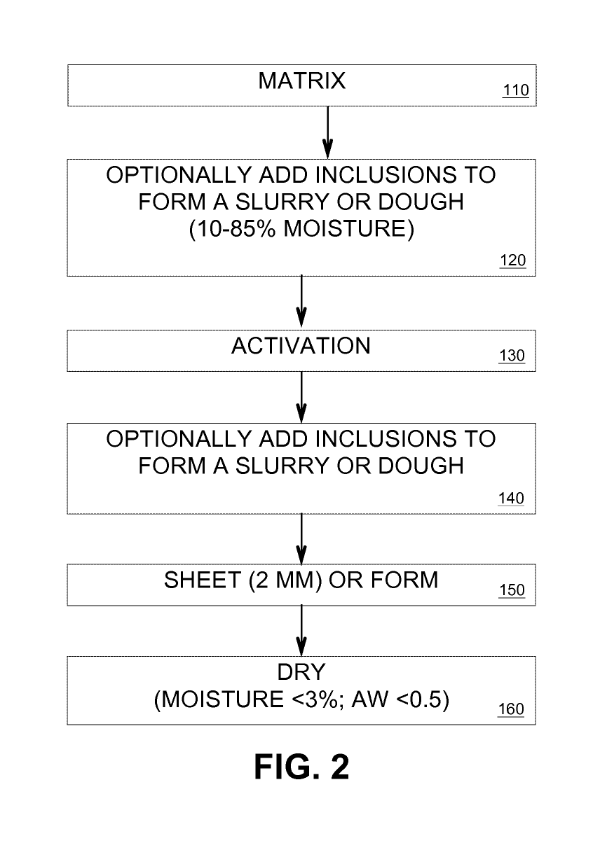

FIG. 2 presents a flow chart of embodiments of methods of forming a composition. Referring to FIG. 1, method 100 includes forming a matrix including at least one a carbohydrate ingredient and/or at least one protein ingredient (block 110). The matrix may be formed by mixing the at least one carbohydrate ingredient and/or protein ingredient in a bowl with an electric mixer. According to one method, one or more inclusion may be blended with the at least one carbohydrate ingredient and/or protein ingredient (block 120). In one embodiment, a matrix is formed when the at least one carbohydrate ingredient and/or protein ingredient with or without the one or more inclusion takes the form of a dough. A representative moisture content of the dough is 10 percent to 95 percent by weight. In one embodiment, a moisture content of a dough is on the order of 20 percent to 80 percent by weight. A relatively high moisture content in a dough (e.g., 80 to 95 percent) can also be described as a slurry.

Following forming a matrix of a dough, the matrix is activated (block 130). Representatively, the matrix may be activated by exposing the matrix to an activation energy source, such as an infrared or microwave radiation source for a dwell time on the order of 30 to 300 seconds. In one embodiment, following the activation, one or more inclusions may be added to the activated matrix (block 140). Such one or more inclusions may be the only inclusions added or may be in addition to inclusions added previously. Following the optional addition of inclusions to the activated matrix, the matrix is formed into a sheet or other form. A representative thickness of such sheet or other form is 2 millimeters (mm) to 10 mm. Following the forming of the sheet or other form, the composition is dried (block 160). A representative moisture content is less than 3 percent moisture content.

### EXAMPLES

### Example 1

### Protein+Inclusion

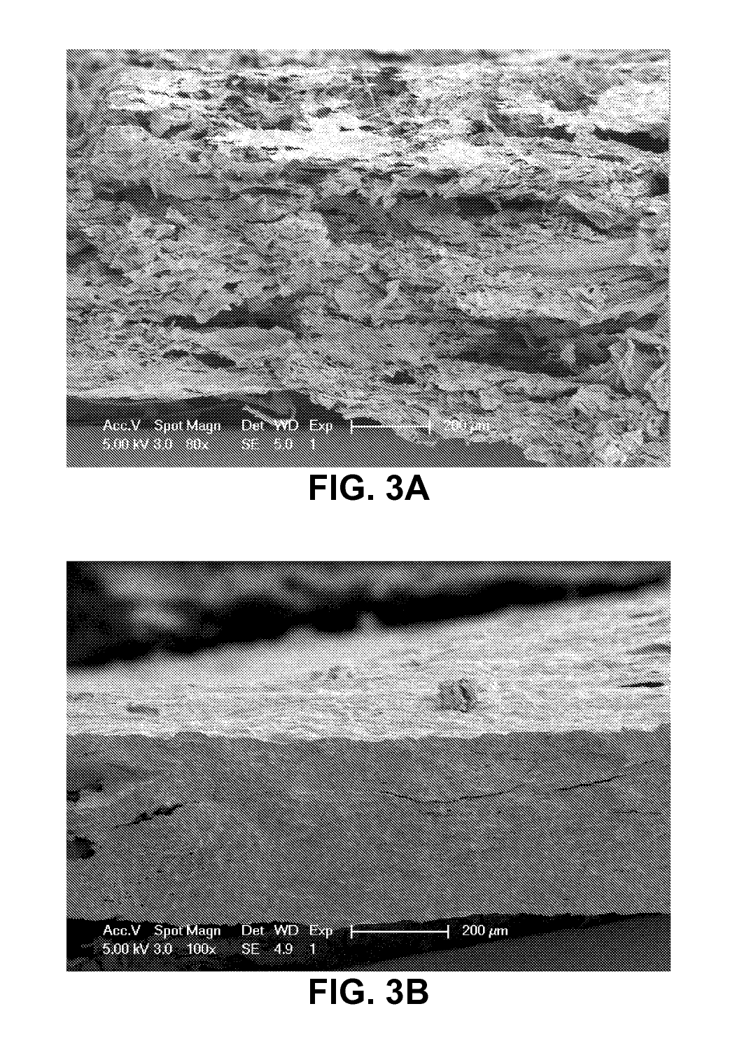

The presence of matrix ingredients in the formation of a composition as described herein is demonstrated in FIGS. 3A and 3B. FIG. 3A shows an electron micrograph of dehydrated beet pomace, dried with no matrix. FIG. 3B shows an electron micrograph of a dough of a matrix including beet pomace that is activated with IR and dried. In this embodiment, the dough is formed using whole food high protein algae with beet pomace as an inclusion, at 55 percent of dry weight. In order to form the dough, the high protein algae is added to the pomace within a basin of an electric mixer, and blended. At first, the beaters flow through the pomace, and the pomace exhibits only minimal cohesion from irregular particle shapes and surface tension of the water within it. Once the high protein algae is added, the pomace begins to stick together and form a dough. After approximately 30-60 seconds at medium speed, a dough begins to form and cling to the mixer blade, leaving the sides of the mixer basin mostly uncoated. At this point, the speed of the mixer is increased to high, which kneads the dough. After approximately two minutes on high speed, the dough cohesion drops, and adhesion increases; this is evidenced by the dough beginning to stick to the bottom and sides of the mixing basin, and the dough ball easing away from the beater. Now the dough is fully incorporated and ready for activation. In one embodiment, the observed reduction in cohesion and increase in adhesion are believed to be a result of interactions between the functional components in high protein algae and the pomace. In another embodiment, the observed textural changes are believed to be due to moisture release from within the pomace, either from osmotic draining, or from mechanical damage of vegetable tissue and subsequent leaking of moisture previously found within the vegetable tissue.

FIG. 3A shows dehydrated beet pomace without any added matrix. In this micrograph, dehydrated pomace exhibits a comparatively high degree of plant tissue and cell wall preservation with many interstitial spaces preserved from the native plant tissue. Without matrix addition, pieces of desiccated tissue do not adhere to one another, but layer loosely upon one another. As depicted in FIG. 3B, the addition of matrix causes or substantially contributes to cementation and compaction of the beet tissue; residual tissue within pomace agglomerates, interstitial spaces are reduced, and the product exterior surfaces hold the shape of the final forming step, creating a comparatively uniform piece surface upon drying. FIG. 3A shows a greater degree of porosity of the tissues when compared to the dried beet pomace with the matrix in FIG. 3B.

### Example 2

### Protein+Carbohydrate Starch+Spinach Inclusion

Whole food algae (11 percent dry weight) as a protein-rich source, and tapioca starch (35 percent dry weight) as a carbohydrate-rich source are mixed in a matrix with a spinach pomace inclusion (52 percent dry weight) forming the dough. IR was used as the energy activation step, at a duration of 80 seconds. The use of a whole food protein algae and starch matrix retained higher levels of bioactives from the spinach (Chlorophyll A, Chlorophyll B, and some of the carotenoids) and algae (lutein/carotenoids), relative to the same spinach pomace activated and dried without a matrix, such that the final dried chip is considered to be a nutrition delivery system.

### Example 3

### Protein+Carbohydrate+Spinach Pomace

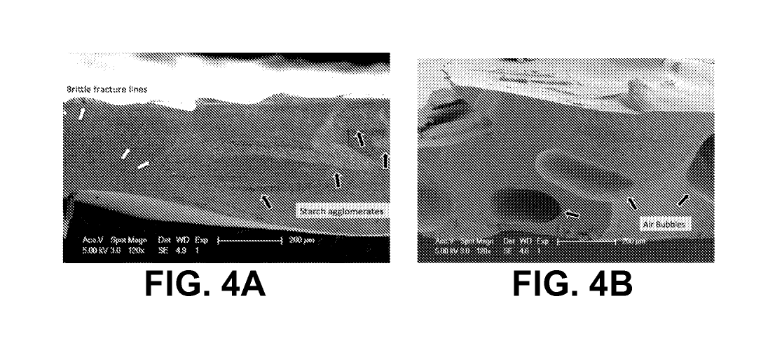

This example illustrates the requirement for activation of the matrix in order to form a composition of a chip, and retain nutrients of the starting materials. This chip was created using a matrix of a protein-rich source (whole food high protein algae) and a carbohydrate-rich source (tapioca starch) with spinach pomace as the inclusion. Organoleptically, we do not form a crunchy chip without the activation step, and as observed there is a significant difference in microstructure as observed in the SEMs in FIG. 4A and FIG. 4B. FIG. 4A shows a scanning electron micrograph illustrates a non-activated matrix and FIG. 4B an activated matrix with final air drying to form a chip. The finished chip was composed of protein and carbohydrate with a spinach inclusion.

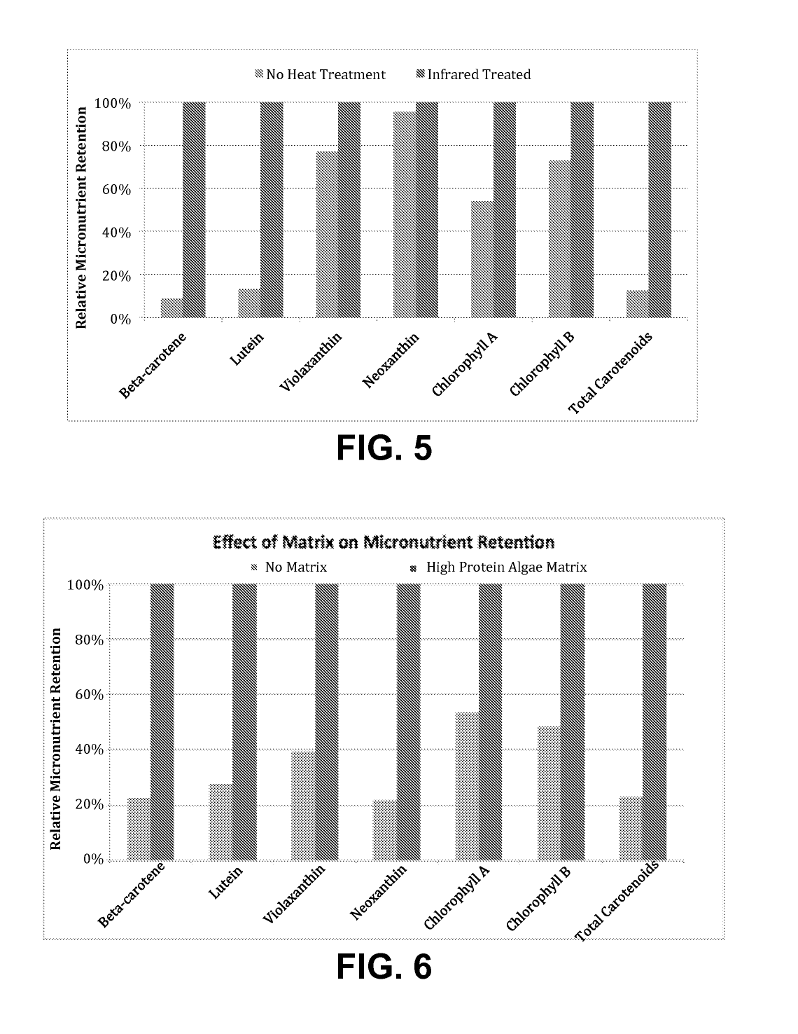

FIG. 5 shows a graph comparing the relative retention of micronutrients/bioactives in a composition in the form of a chip made with and without activation of the matrix with IR and a final air-drying to form a chip. The finished composition was composed of protein and carbohydrate with a spinach inclusion. The actual nutrient data for spinach chips made with no activation and with activation in shown in Table 2.

TABLE 2

| | No Activation | Activated |
|---|---|---|
| Beta-carotene (mcg/g) | 52.8 | 602.7 |
| Lutein (mcg/g) | 178.5 | 1350.5 |
| Violaxanthin (mcg/g) | 18.8 | 24.4 |
| Neoxanthin (mcg/g) | 6.3 | 6.6 |
| Chlorophyll A (mcg/g) | 387 | 716 |
| Chlorophyll B (mcg/g) | 102 | 140 |
| Total Carotenoids (mcg/g) | 270.3 | 2156.1 |

FIG. 6 shows a graph comparing the relative retention of micronutrients/ bioactives in a composition in the form of a chip made with and without matrix. Both chips activated with infrared radiation and a final air-drying to form a chip. The finished chip was composed of either dried spinach pomace alone, or high-protein algae matrix with a spinach inclusion. As seen in FIG. 5 and Table 2, the retention of micronutrients is significantly higher for beta-carotene, lutein, total carotenoids, and chlorophylls A and B, compared to finish drying without a prior activation. In one embodiment, the composition following energy activation and drying includes an amount of one or more nutrients that is similar, including identical or approximately identical to the amount of the one or more nutrients present in the inclusion prior to its incorporation in the composition.

Table 3 illustrates a nutrient (micronutrient) retention rate of spinach compositions in the form of chips made without or with a matrix. The retention rate was calculated by comparing analytically measured micronutrient content of chips with the sum of micronutrients contained in the raw ingredients prior to incorporation in the chips.

TABLE 3

High Protein Algae

| | No Matrix | Matrix |
|---|---|---|
| Beta-carotene (mcg/g) | 9.07% | 39.97% |
| Lutein (mcg/g) | 16.24% | 58.37% |
| Violaxanthin (mcg/g) | 2.82% | 7.15% |
| Neoxanthin (mcg/g) | 1.22% | 5.58% |
| Chlorophyll A (mcg/g) | 2.41% | 4.50% |
| Chlorophyll B (mcg/g) | 1.74% | 3.58% |
| Total Carotenoids (mcg/g) | 10.60% | 46.01% |

### Example 4

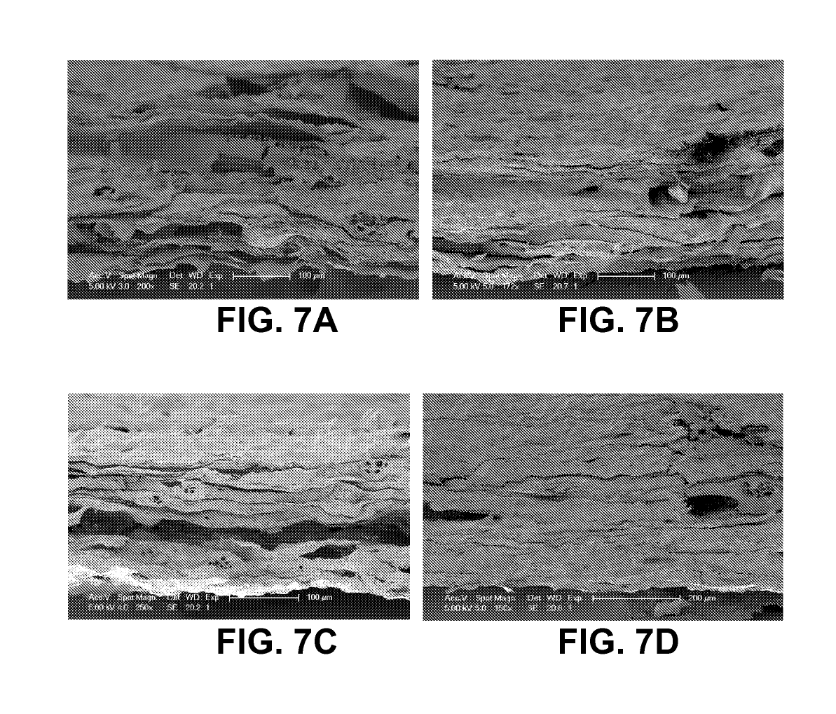

The requirement for a matrix and activation of the matrix (with spinach pomace as an inclusion) in order to form a crunchy structure is depicted in FIG. 7A-7D. FIG. 7A shows a micrograph of spinach pomace alone (no matrix) and only air dried (no activation energy applied). As illustrated in the micrograph, the spinach tissue remains fibrous and papery after air-drying. FIG. 7B shows the spinach pomace combined with a protein-rich matrix (14 percent algae by weight of dried composition) and air dried (no activation energy applied). As seen in FIG. 7B, there is a slight amount of tissue cementation from the algae matrix upon air-drying, but fibrous layered interstitial spaces remain. FIG. 7C shows spinach pomace alone (no matrix) after application or exposure to IR activation energy. As seen in FIG. 7C, the activation energy produces moderate cementation of the spinach pomace. FIG. 7D shows the spinach pomace combined with an algae matrix (14 percent algae by weight of dried composition), IR energy activated and air dried. The combined effects of matrix and activation on spinach pomace forms a fully cemented, coherent sheet as illustrated in the micrograph of FIG. 7D. Organoleptically, the finished chip containing activated, air-dried protein-rich matrix has a fracturable and crunchy texture similar to a fried chip. The chips that contained no matrix were found to be less crunchy, less fracturable (more pulpy), and not similar to a fried chip.

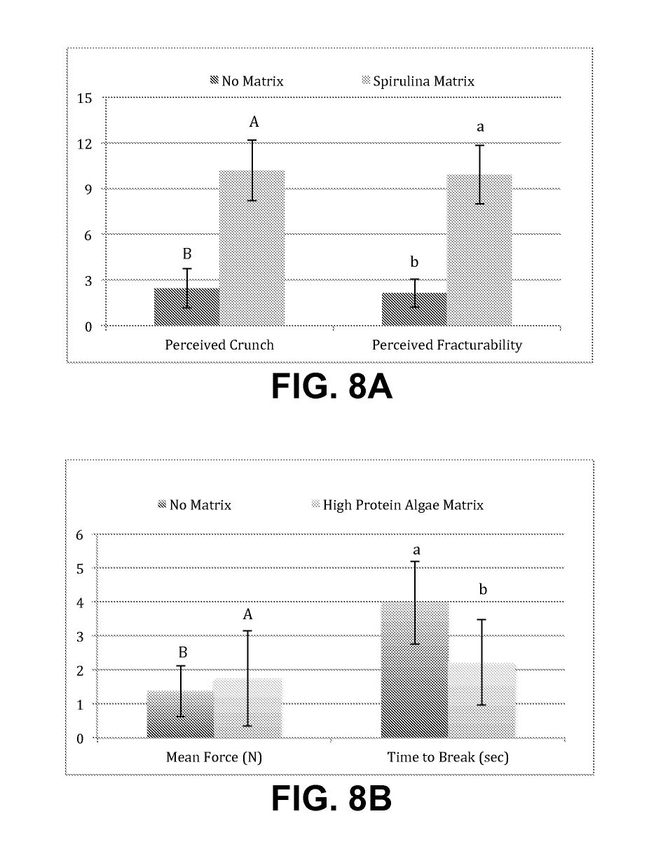

FIGS. 8A-8B shows graphs of spinach pomace chips made with and without a protein-rich matrix with a protein-rich matrix are significantly more crunchy and more easily fracturable, and have a higher mean fracture force, compared to spinach pomace chips made without a matrix.

### Example 5

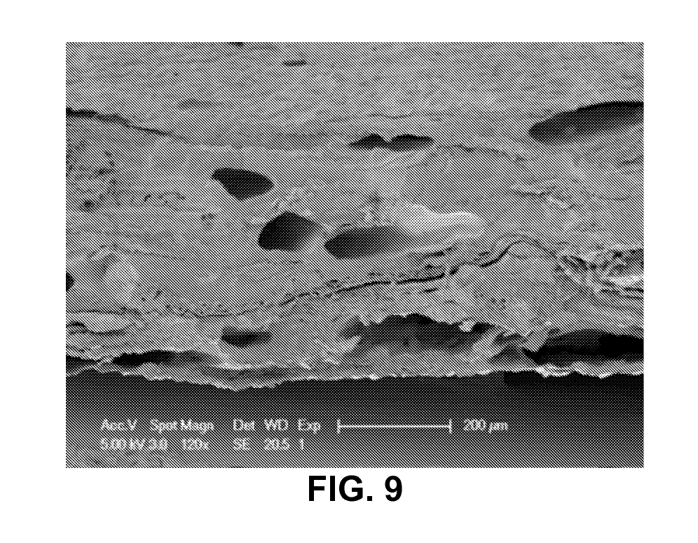

FIG. 8 shows an electron micrograph of a carbohydrate (tapioca starch) matrix, with spinach pomace as the inclusion. As in FIG. 7D, a cohesive crunchy chip containing air is formed. The incorporation of air adds to the perception of crunchy texture. The texture of this chip compared to a chip made with no matrix (as in FIG. 7A), is statistically crunchier and more easily fractured as measured organoleptically (as seen in FIG. 9) and by texture meter: requires a higher mean force and lower time to break (sec).

FIG. 9 shows a chip made with a starch matrix, spinach pomace inclusion, IR activation and air-drying.

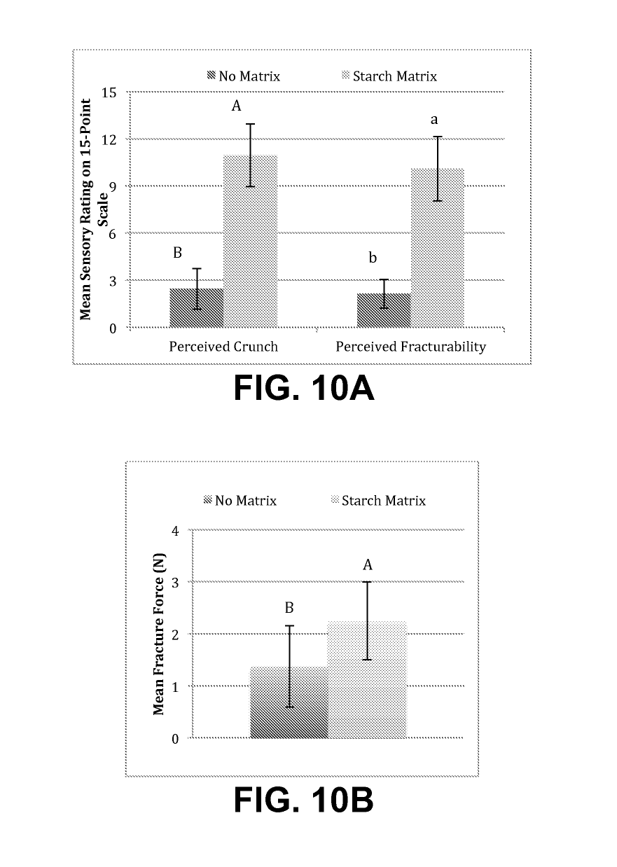

FIGS. 10A-10B show chips made with a starch matrix binding spinach pomace are significantly more crunchy and more easily fracturable, and have a higher mean fracture force, compared to spinach pomace chips made without a matrix.

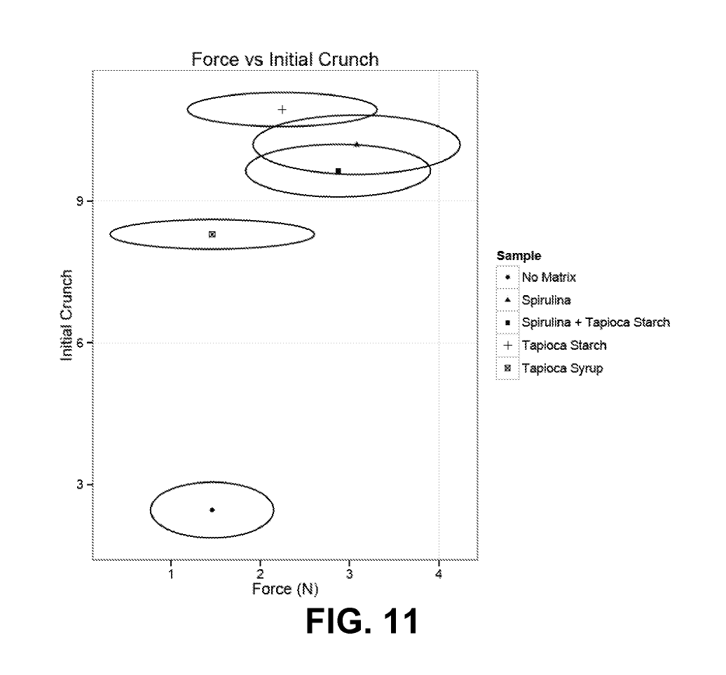

FIG. 11 show spinach pomace chips made with either of multiple matrices perform significantly better than chips made with no matrix, according to organoleptic and texture meter data. FIG. 11 illustrates the functionality of the matrix. Organoleptic data on initial crunch and force data as measured using the texture meter show that a different crunch was created using a matrix than when not using a matrix. Furthermore, the matrix composition can vary within the parameters set for carbohydrate and protein percentages. The source of these proteins and carbohydrates may vary.

### Example 6

The following tables present example formulas and nutritional panels for several embodiments.

### Example 6A

### Formula for Dough (Wet Weight)

| Ingredient | Recipe % |
|---|---|
| tapioca starch | 8.77% |
| algae (whole food high protein) | 3.51% |
| spinach pomace (wet) | 87.72% |
| sum | 100.00% |
| Nutrition Facts | |
| Calories | 210 |
| Calories from fat | 15 |
| | % Daily Value |
| Total Fat 2 g | 3% |
| Protein 11 g | 22% |
| Vitamin A | 30% |
| Calcium | 6% |
| Vitamin C | 45% |
| Iron | 20% |

### Example 6B

### For Matrix with Flavor

| Ingredient | Recipe % |
|---|---|
| Natural flavor | 50% |
| Water | 40% |
| Algae (whole food high protein) | 10% |
| sum | 100.00% |
| Nutrition Facts | |
| Calories | 420 |
| Calories from fat | 40 |
| | % Daily Value |
| Total Fat 4.5 g | 7% |
| Protein 41 g | 82% |
| Vitamin A | 0% |
| Calcium | 2% |
| Vitamin C | 0% |
| Iron | 4% |

### Example 6C

### For Matrix Alone as a Crunchy Chip or Piece

| Ingredient | Recipe % |
|---|---|
| Water | 80% |
| Algae (whole food high protein) | 20% |
| sum | 100.00% |
| Nutrition Facts | |
| Calories | 410 |
| Calories from fat | 100 |
| | % Daily Value |
| Total Fat 11 g | 17% |
| Protein 64 g | 128% |
| Vitamin A | 0% |
| Calcium | 8% |
| Vitamin C | 2% |
| Iron | 10% |

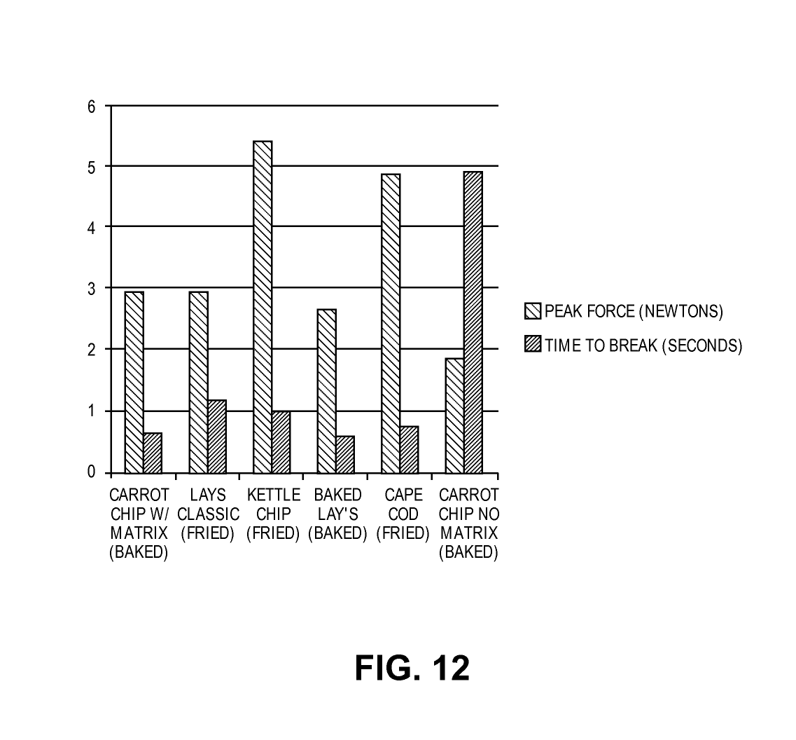

FIG. 12 shows a comparison of several commercial brands of fried/baked potato chips in comparison to carrot chips with and without a matrix. The carrot chip with matrix (baked) is a protein coated carrot strip that has undergone the activation and drying process. The carrot chip with no matrix underwent the activation and dehydration process.

“Fracture-ability” is an important attribute of (fried) potato chips as described by expert tasters. The chip must “fracture” or break apart quickly into small pieces and not get pulpy upon chewing. The carrot chip with matrix was described by the experts as fracturable, with a texture similar to a fried potato chip.

There are two texture measurements that can correlate with the sensory term “fracture-able”: peak force (Newtons) and time to break (seconds). The carrot chip with matrix (baked) was similar to (not significantly different from P<0.05) some of the fried chips in both measurements. Furthermore, the carrot chip with no matrix (baked) was very different (statistically, P<0.01) to the all of the chips evaluated for both peak force and time to break indicating that the process described herein of activating a matrix is important to making a baked crunchy vegetable/fruit based chip competitive to current baked and friend brand leaders. Visually, there was outstanding color, flavor retention, and shelf life for the protein coated carrot chip.

1. A composition in a glass-like state comprising a matrix of at least one of a carbohydrate ingredient and a protein ingredient.

2. The composition of claim 1, further comprising an inclusion.

3. The composition of claim 2, wherein the inclusion is selected from the group consisting of at least one of a seed portion, a fruit portion, a vegetable portion, a legume portion and a nut portion.

4. The composition of claim 2, wherein the inclusion is selected from the group consisting at least one of a spice portion and an herb portion.

5. The composition of claim 2, wherein an amount of inclusion is up to 95 percent of the composition.

6. The composition of claim 2, wherein the inclusion retains an amount of one or more nutrients in the composition.

7. The composition of claim 2, wherein the inclusion is an auxiliary inclusion of one of a gas and a flavor.

8. The composition of claim 1, wherein the inclusion comprises at least one of a fruit portion and a vegetable portion and a serving size of the composition comprises up to three servings of the inclusion.

9. The composition of claim 1, wherein the matrix is a protein ingredient and the inclusion is a vegetable portion.

10. The composition of claim 9, wherein the vegetable portion comprises one of a beet portion and a spinach portion.

11. The composition of claim 9, wherein the protein ingredient comprises algae.

12. A composition comprising a matrix of at least one of a carbohydrate ingredient and a protein ingredient and an inclusion, wherein the composition comprises an amount of one or more nutrients in the composition provided by the inclusion that is greater than an amount of the one or more nutrients in the inclusion processed without a matrix.

13. The composition of claim 12, wherein the inclusion is selected from the group consisting of at least one of a fruit portion, a vegetable portion, a legume portion, a seed portion and a nut portion.

14. The composition of claim 12, further comprising an auxiliary inclusion of at least one of a gas and a flavor.

15. The composition of claim 12, wherein an amount of inclusion is 30 to 95 percent of the composition.

16. The composition of claim 12, wherein the composition comprises a glass-like state.

17. The composition of claim 12, wherein the inclusion comprises at least one of a fruit portion and a vegetable portion and a serving size of the composition comprises up to three servings of the inclusion.

18. A method comprising:
forming a dough comprising a matrix comprising at least one of a carbohydrate ingredient and a protein ingredient;
energy activating the dough; and
forming a composition comprising a glass-like state.

19. The method of claim 18, wherein the energy activating is exposing the dough to one of infrared energy and microwave energy.

20. The method of claim 18, wherein forming the composition comprises drying after energy activating.

21. The method of claim 18, further comprising combining at least one inclusion with the dough.

22. The method of claim 21, wherein the inclusion is combined with the dough prior to energy activating.

23. The method of claim 21, wherein the inclusion is combined with the dough after energy activating.

24. The method of claim 21, wherein the inclusion is selected from the group consisting of at least one of a fruit portion, a vegetable portion, a seed portion, a legume portion and a nut portion.

25. The method of claim 24, wherein the composition comprises an amount of one or more nutrients in the composition provided by the inclusion that is greater than an amount of the one or more nutrients in the inclusion processed without a matrix.

26. The method of claim 21, wherein the inclusion is selected from the group consisting at least one of a spice portion and an herb portion.

27. The method of claim 18, wherein the inclusion comprises an auxiliary inclusion of at least one of a gas and a flavor.

28. The method of claim 18, wherein energy activating inhibits at least one of oxidation, enzymatic degradation and volatile flavor loss.
